(19) United States
(12) Patent Application Publication
(10) Pub. No.: US 2024/0125894 A1
(43) Pub. Date: Apr. 18, 2024

(54) RADAR SYSTEM AND CORRESPONDING METHOD

(71) Applicant: Symeo GmbH, Neubiberg (DE)

(72) Inventors: Perter Gulden, Erding (DE); Michael Gottinger, Buckenhof (DE); Martin Vossiek, Fürth (DE); Marcel Hoffman, Erlangen (DE)

(21) Appl. No.: 18/276,401

(22) PCT Filed: Jan. 31, 2022
(86) PCT No.: PCT/EP2022/052199

§ 371 Date: Aug. 8, 2023

(30) Foreign Application Priority Data
Feb. 8, 2021 (DE) 10 2021 102 897.3
Jul. 13, 2021 (DE) 10 2021 118 076.7

(51) Int. Cl. G01S 7/03; G01S 13/931

(52) U.S. Cl. CPC G01S 7/03; G01S 13/931

(57) ABSTRACT

The present subject matter relates to a radar system for detecting the surroundings of a moving object, in particular a vehicle and/or a transport device, such as in particular a crane, wherein the system is mounted or mountable on the moving object, wherein the radar system comprises at least one first, non-coherent, and at least one second, non-coherent, radar module with at least one antenna, wherein the radar modules are arranged or can be arranged distributed on the moving object, wherein at least one first radar module is configured differently from at least one second radar module.

### CLAIM OF PRIORITY

This application is a U.S. National Stage Application under 35 U.S.C. 371 from International Application No. PCT/EP2022/052199, filed on Jan. 31, 2022, which claims the benefit of priority of (1) DE Application No. 102021102897.3, filed on Feb. 8, 2021, and (2) DE Application Serial No. 102021118076.7, filed on Jul. 13, 2021, the benefit of each of which are hereby presently claimed, and each of which are hereby incorporated by reference herein in their entirety.

### TECHNICAL FIELD

The disclosure relates to a radar system, in particular for detecting the surroundings of an object, and a corresponding method.

### BACKGROUND

In OFDM-Based Radar Network Providing Phase Coherent DA Estimation, Werbunat et al, IEEE TRANSACTIONS ON MICROWAVE THEORY AND TECHNIQUES, VOL. 69, NO. 1, JANUARY 2021, an OFDM-based radar network is proposed in which repeaters are used to build up a coherent network. However, especially in dynamic situations and/or situations with a comparatively high number of targets, this method is considered to be only slightly practicable.

A radar system is further known from DE 10 2017 110 063 A1. According to this, distributed incoherent radar units for detection of surroundings can also be operated coherently (through suitable signal processing) in the automotive sector. Hereby, for example, any virtual MIMO aperture can be generated by a defined distribution of the individual radar units (which in principle can be of any structure).

### SUMMARY

It is considered problematic that a comparatively high angular resolution is accompanied by a comparatively high space requirement. It is therefore an object of the disclosure to propose a radar system, in particular for mobile applications, with which a comparatively high accuracy (in particular angular resolution) can be achieved, whereby the space requirement should be comparatively low. Furthermore, it is object of the disclosure to propose a corresponding method.

In particular, the object is solved by a radar system for detecting the surroundings, in particular of a, preferably moving, object, in particular of a vehicle and/or of a transport device, such as in particular of a crane, wherein the system preferably is mounted or mountable on the object, and/or for stationary application, wherein the radar system comprises at least two (preferably to each other non-coherent) radar modules with at least one transmitting and at least one receiving antenna, wherein the radar modules (in particular on the object) are arranged or arrangeable distributed, wherein at least one first (optionally several or all first) radar module(s) is configured differently from at least one second radar module, preferably being larger and/or having more receiving and/or more transmitting antennas than at least one second (possibly several or all of the second) radar module(s).

An idea of the disclosure lies therein to provide several radar modules (at least one first as well as at least one second) which are configured differently from each other, in particular with regard to their geometry and/or configuration.

Preferably, only one or only a few (e.g., two) comparatively large (first) radar module(s) are arranged and several comparatively small radar modules. In this way, advantages resulting from a comparatively largely built radar module (in which a correspondingly high number of antennas can be arranged and/or several antennas can be arranged at a comparatively large distance from each other) can be combined with the advantages of a plurality of radar modules provided in total. Overall, a virtual aperture can thus be comparatively densely occupied. The accuracy is improved.

Under a radar module is preferably to be understood an assembly which can be defined, for example, by a housing and/or a base body (e.g., plate) on which the corresponding components of the respective module are mounted.

In particular, a radar module basically has at least one transmitting antenna as well as one receiving antenna and/or at least one transmitting/receiving antenna.

In addition to a transmitting and/or receiving antenna, (any) radar module may have an oscillator and possibly AD converters. It is also possible to apply a signal of only one oscillator to several (in particular several second) radar modules. For example, at least two or at least four second radar modules may operate with only one oscillator.

By a radar module is to be understood in particular a module which has (its own) (radar) signal generator, preferably comprising an oscillator, as well as optionally a modulator. In particular, the at least one first and the at least one second radar module is not a repeater (as for example in the above article by Werbunat et al). The repeaters of Werbunat et al do not have their own signal generator (and no oscillator) (but merely modulate an existing signal). In particular, in case of an FMCW radar, the oscillator may be a VCO.

Preferably, each first radar module has its own oscillator (although this is not mandatory). By an “own” oscillator it is to be understood in particular that an oscillator is provided which is only associated with the respective radar module.

### BRIEF DESCRIPTION OF THE DRAWINGS

FIG. 1 a motor vehicle according to the disclosure in a schematic front view;

FIG. 2 a schematic representation of a radar array configuration;

FIG. 3 a schematic representation of a virtual radar array according to the array configuration of FIG. 2;

FIG. 4 diagrams of different radar signals (azimuth);

FIG. 5 diagrams for different radar signals (azimuth);

FIG. 6 an alternative array configuration;

FIG. 7 a virtual array of the array configuration according to FIG. 6;

FIG. 8 diagrams for radar signals (elevation and azimuth);

FIG. 9 diagrams for radar signals (elevation and azimuth);

FIG. 10 a representation of a virtual radar array with redundant elements;

FIG. 11 a representation of a virtual radar array with redundant elements;

FIG. 12 an alternative array configuration including the corresponding virtual array and diagrams of radar evaluations (elevation and azimuth);

FIG. 13 a schematic representation of an arrangement of second radar modules;

FIG. 14 a schematic representation of a first radar module; and

FIG. 15 a motor vehicle with a radar system according to the disclosure in a schematic representation.

### DETAILED DESCRIPTION

With regard to the above-mentioned article by Werbunat et al, it was recognised that the repeater signal mentioned there traverses the transmission channel (i.e. usually air with all structures arranged therein) twice. Because of that the repeater signal is influenced doubly, which influences (or distorts) the signal as a whole comparatively strongly. For a larger number of targets (and thus especially for dynamic road traffic scenes), an allocation can probably no longer be guaranteed with the above state of the art and the method no longer works satisfactorily in practice. Even for comparatively large distances, it is to be assumed that the above method according to the prior art will no longer function sufficiently reliably due to the system, since a reception power of the repeater signal decreases comparatively strongly.

The repeater per se presumably does not introduce any additional phase noise, but also the amplifier according to the prior art will not be able to amplify without noise (which is particularly relevant for longer distances).

Overall, it is to be noted that the solution according to the prior art in comparison to the present disclosure, is at best useful in scenarios with very few targets, for comparatively short distances and with a comparatively clean transmission channel (for example, antenna measurement chamber).

The radar system preferably comprises at least one (electronic) evaluation unit. This can be at least partially part of a (in particular a first) radar module and/or at least partially formed by a (possibly central) evaluation unit external to the radar modules. The evaluation unit is preferably configured to record and evaluate transmitting and receiving signals of the respective radar modules. Particularly preferably, the evaluation unit is configured to process transmitting and receiving signals from at least one first radar module and at least one second radar module in such a way that the at least one radar module is virtually folded to a position of the at least one second (in particular comparatively small) radar module (or that with the aid of at least one/the small, second radar module at least one module can be generated virtually which has the size of the first radar module).

Basically, it is an idea of the disclosure to provide one first (in particular larger) radar module and at least one second (in particular smaller) radar module, which is in particular spatially separated from the first radar module—and does not have to be (but can be) coherent with the first radar module. This second (smaller) radar module is preferably used to virtually fold the first (larger) radar module to the position of the further radar module. Thus, the first (comparatively large) radar module is virtually brought to a position where the second radar module is physically provided. Overall, a plurality of virtual radar modules (or virtual radar elements) can thus be realised, which can also be provided at locations that cannot (or at least cannot sensibly) be occupied by a physical radar module. With comparatively little effort, an improvement of the process can be achieved.

Several or all second radar modules can have a distance (to the respective nearest neighbour) which is at least 1 cm or at least 3 cm and/or at most 20 cm. If several first radar modules are provided, they may have a distance of at least 50 cm and/or at most 100 or at most 25 or at most 3 m.

By a “size” of a radar module shall preferably be understood its maximum extension (as distance of that pair of points among all pairs of points of the radar module with the greatest distance to each other).

Alternatively or additionally (at least in the case of symmetrical, for example cuboidal designs), the extension along an axis of symmetry can also be understood as size. In general, a size can be understood as the width, height and/or length of a radar module, wherein the length preferably forms the maximum extension (or, in case of symmetrical shapes, the maximum extension along that axis of symmetry where the maximum extension is present).

The size can, for example, alternatively or additionally also be understood as a volume (within a housing of the radar module and/or within an envelope defined by the respective radar module) and/or as a weight.

The (respective) size of the (respective) at least one first (optionally several or all first) radar module(s) may be at least 1.5 times, optionally at least 2 times or at least 5 times as large as the size of at least one (optionally several or all) second radar module(s).

Several or all of the first radar module(s) may be of the same size. Alternatively or additionally, this also applies to the second radar modules. However, both first as well as second radar modules may also have (within the respective group of radar modules) different sizes (or otherwise be formed in different ways). If this is the case and sizes are to be compare, an arithmetic mean shall preferably be used for the respective “size” when several first radar modules are compared with several second radar modules.

At least one or several or all second radar module(s) may have a size (in particular height and/or width and/or length) of at least 4 mm or at least 8 mm and/or at most 100 cm or at most 25 cm or at most 4 cm. At least one or several or all first radar module(s) may have a size of at least 3 cm or at least 5 cm and/or at most 40 cm.

It has been recognised that large radar modules with high angular resolution are comparatively complicated to manufacture and require a large amount of space, which may, for example, complicate the air intake of a car if a radar module is located in the corresponding region (of the air intake). In principle, the achievable resolution is indirectly proportional to the geometric dimensions of a radar sensor (radar module).

According to the present disclosure, additional radar modules are preferably distributed in order to generate at least a comparatively large overall aperture. A corresponding virtual array (of the entire arrangement of radar modules) may be occupied, for example, one-dimensionally or two-dimensionally. In a centre of a (possibly moving) object (in particular motor vehicle), for example, only comparatively small (second) modules can be used. These can, for example, consist of only one antenna element and be configured in such a way that they do not require an RF connection (i.e. in particular no connection to an RF signal with a frequency in the range of more than 1.0 GHz).

Particularly preferably, several or all second radar modules may be arranged on a common component, for example made of plastic. The component can be a strip and/or lamella and/or a grid, in particular in the region of an air intake. The component may be comparatively thin (e.g., with a thickness of less than 5 cm) and/or elongated (e.g., have a length of at least 20 cm or at least 40 cm). With such an arrangement, a comparatively high mechanical stability can be achieved and/or a connection to a bus system can be made possible. If necessary, several elongated structures (strips) can also be arranged next to each other and/or on top of each other (with second radar modules arranged there accordingly).

Preferably, the radar modules are arranged in such a way that corresponding (virtual) elements of (neighbouring) virtual arrays overlap (that is in particular be arranged in the same region or at the same location). In this way, deviations, e.g., installation errors, can preferably be estimated and/or corrected initially and/or during operation. If necessary, it can be assumed (in the far field) that a phase offset of the overlapping elements is at least essentially the same. If a deviation occurs, for example due to an installation error and/or an expansion during drive, this deviation can be estimated and/or corrected.

Alternatively or in addition to the methods described in DE 10 2017 110 063 A1 (there referred to as “method I” or “method II”), a coherent operation or a coherent processing of basically non-coherent radar modules can be achieved by means of a phase correction based on (or by means of) the overlapping elements.

In a setup according to one embodiment, for example, a larger radar module (e.g., an ordinary ACC radar, ACC=adapted cruise control) with at least or exactly one transmitting and, for example, at least four or exactly four or at least eight or exactly eight receiving channels can be provided. Besides that, further (comparatively small or second) radar modules, for example with exactly one transmitting and receiving channel, can be used. In principle, the division of transmitting and receiving channels as well as the arrangement of the comparatively small radar modules and the comparatively large radar modules on an object can be chosen freely or according to the requirements of the respective application.

At least one or several or all second radar module(s) may (preferably in contrast to at least one or several or all first radar module(s)) have only one transmitting antenna and/or only one receiving antenna and/or only one transmitting-receiving antenna. By this the second radar module(s) can be formed comparatively small-building.

At least one evaluation device for the evaluation of transmitting and/or receiving signals can be provided, which is preferably configured to process transmitting and receiving signals of the radar modules into modified measurement signals in such a way that the modified measurement signals are coherent with one another. Such a processing can be done, for example, according to one or more of the methods described in DE 10 2017 110 063 A1 (in particular method I and/or method II) and/or (in particular in the case of overlapping virtual elements) by two virtual radar arrays formed by the system.

At least two of the radar modules (for example, two of the first radar modules and/or two of the second radar modules and/or at least one first and at least one second radar module) may be interconnected via a communication channel, in particular a bus system. This can preferably be done (in particular in the case of a connection of several second radar modules) via a strip and/or slat and/or a grid.

According to a furthering, but possibly also independent idea, at least one (possibly several or all) second radar module(s) can be arranged on a, in particular thin, strip and/or slat. Alternatively or additionally, at least one radar module, in particular at least one second and/or at least or exactly one first (in alternatives, however, no first) radar module can be arranged in the region of an air intake (for example in a front region of a motor vehicle) and/or in the region of a grid, in particular for an air intake and/or below a number plate mounting region or below a number plate and/or in a region of a moving object. Under a lower region of the moving object is preferably to be understood a section of the moving object which extends over a maximum of 50% of the (maximum) height of the object, possibly over 30% of this height.

At least one first radar module may have at least or exactly one transmitting antenna and/or at least two or at least four or at least eight and/or at most 100 receiving antennas.

In embodiments, at least one first (alternatively no first) radar module and/or at least one second radar module may be arranged in the centre of the moving object, preferably exclusively in the centre of the moving object. In the case of several corresponding radar modules, this preferably applies to at least one, preferably a subgroup, possibly all of the radar modules.

By the centre of the moving object is preferably to be understood a region which extends over the entire width of the moving object, excluding the regions which extend from the respective edges up to 10%, optionally up to 25% of the width in the direction of the respective other edge.

Alternatively or additionally, at least one second radar module may be arranged between at least two or exactly two first radar modules (if applicable, this applies to several or all second radar modules).

Alternatively or additionally, at least one, possibly several or all second radar module(s) may have a smaller distance to at least two first radar modules than the two first radar modules have to each other.

At least one or several or all of the first radar module(s) may optionally be arranged (in relation to the width of the moving object) at edge regions, wherein an edge region is preferably a region that does not belong to the centre of the moving object (motor vehicle).

In total, at least or exactly one or at least or exactly four or at least or exactly eight or at least or exactly 16 or at least 100 and/or at most 10000, possibly at most 500, second radar modules may be provided.

The second radar modules may, for example, alternatively or additionally also be arranged in and/or along an A-pillar.

According to embodiment, it is proposed that a first signal is generated in one of the radar modules and transmitted, in particular radiated, via a path, a further first signal is generated in a further one of the radar modules and transmitted, in particular radiated, via the path, in an/the evaluation device, in particular in the one radar module, a first comparison signal is formed from the first signal of the one radar module and from such a first signal received from the further radar module via the path, and in an/the evaluation device, in particular in the further radar module, a further comparison signal is formed from the first signal of the further radar module and from such a first signal received from the first radar module via the path, wherein the further comparison signal is preferably transmitted, in particular communicated, from the further radar module to the one radar module.

According to a further embodiment, it is proposed that the system, in particular an/the evaluation device is configured for the formation of a comparison signal from the first comparison signal and the further comparison signal.

According to preferred embodiments, it is proposed that the system, in particular the evaluation device, is configured to, in a first step, compensate for deviations of the comparison signals which are caused by systematic deviations in the radar modules and to, in a second step, use at least one complex value from a first of the two comparison signals or from a signal which was derived from this first comparison signal, to adapt at least one complex value of the second of the two comparison signals or a value of a signal which was derived from this second comparison signal and thus to form an adapted signal, wherein the adaptation is done in such a way that by a mathematical operation the vectorial sum or the difference of the complex values is formed or the sum or the difference of the phases of the complex values is formed.

According to alternative embodiments, it is proposed that the comparison comparison signal, in that the two comparison signals are processed with each other—in particular multiplied conjugatedly complex—corresponds to a comparison signal generated with a coherent radar system.

Alternatively or additionally, the system (in particular the/an evaluation device) may be configured to enable a coherent processing, that is preferably via phase correction, further preferably on the basis of overlapping elements of at least two virtual radar arrays.

At least two virtual radar arrays may be formed. Each virtual radar array may have at least one (in particular outer) element that overlaps with at least one (in particular outer) element of the respective other virtual radar array.

In principle, the system, in particular the evaluation device, may be configured to perform an online calibration.

In embodiments, the system, in particular the evaluation device, may be configured for an SAR application and/or an imaging method. Preferably, the system is configured as an FMCW radar. Alternatively or additionally, the system may be configured as an OFDM radar.

The evaluation device or evaluation unit is preferably configured to evaluate or display (or output) and possible to combine signals that are transmitted by the at least one first radar module and received by the at least one second radar module and/or signals that are transmitted by the at least one second radar module and received by the at least one first radar module. In a specific embodiment comprising two first radar modules and a plurality of (at least four) second radar modules, which altogether form a group of second radar modules, the evaluation unit can, for example, be configured to evaluate all signals received by the two first radar modules and the group of second radar modules (from the respective other radar module or radar group) (possibly also its own reflected signal).

The above-mentioned object is further solved by a movable object, in particular vehicle, preferably motor vehicle, further preferably automobile and/or transport device, such as in particular crane or part of a crane, comprising a system of the above type.

The above-mentioned object is further solved by a method for the detection of the surroundings of an (preferably moving or movable) object, in particular a vehicle and/or a transport device, such as in particular a crane or a part of a crane, in particular by employing the above system and/or the above (movable) object, wherein (in particular on and/or in the possibly moving object) at least two (preferably mutually non-coherent radar modules) are or will be arranged distributed, wherein at least one first radar module is configured differently from at least one second radar module, is preferably larger and/or has more receiving and/or more transmitting antennas than at least one second radar module.

Transmitting and receiving signals of the radar modules can preferably be processed to modified measurement signals such that the modified measurement signals are coherent with each other.

Preferably, the method is further formed in that in a radar module, a first signal is generated and transmitted, in particular radiated, via a path, in a further radar module, a further first signal is generated and transmitted, in particular radiated, via the path, a first comparison signal is formed from the first signal of the one radar module and from such a first signal received by the further radar module via the path, and a further comparison signal is formed from the first signal of the further radar module and from such a first signal received from the one radar module via the path,
wherein the further comparison signal is preferably transmitted, in particular communicated, from the further radar module to the one radar module (and/or an, optionally central, evaluation unit, such as an optionally central processor of a vehicle) and/or wherein preferably a comparison signal is formed from the first comparison signal and the further comparison signal and/or wherein in a first step deviations of the comparison signals, which are caused by systematic deviations in the receiving-transmitting units, are compensated and in a second step at least one complex value from a first of the two comparison signals or from a signal which was derived from this first comparison signal is used to adapt at least one complex value of the second of the two comparison signals or a value of a signal which was derived from this second comparison signal and thus to form an adapted signal, wherein the adaptation is done in such a way that by a mathematical operation the vectorial sum or the difference of the complex values is formed or the sum or the difference of the phases of the complex values is formed.

The above-mentioned object is further solved by the use of the above system and/or the above movable object and/or the above method for the detection of the surroundings of a moving object, in particular a vehicle and/or a transport device, such as in particular a crane or a part of a crane, in particular for estimating, preferably for determining, a distance and/or an angular position and/or a (vectorial) (relative) speed and/or a (vectorial) (relative) acceleration and/or for generating an image of the surroundings structure.

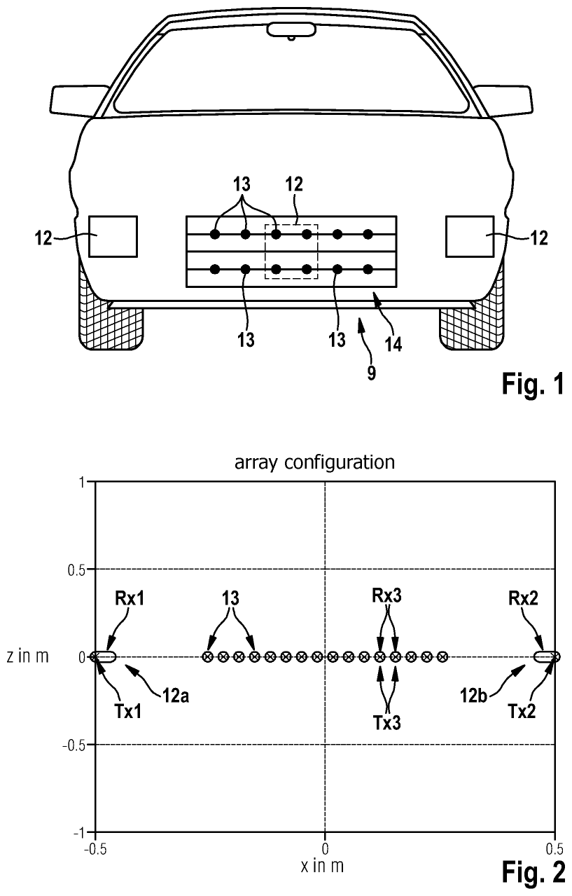

FIG. 1 shows a motor vehicle 9 according to the disclosure in a schematic view from the front.

The motor vehicle 9 has (in a front region) one first or several first radar module(s) 12 as well as a plurality of second radar modules 13. Specifically, three first radar modules 12 are shown (one of which dashed). Preferably, however, only the two outer radar modules 12 (among the radar modules shown) are provided. Alternatively, only the central (drawn in dashed) first radar module 12 may be provided. In further embodiments, also all three (shown) radar modules 12 may be provided.

In addition to the first radar modules 12, the vehicle also has a plurality of second radar modules 13, which are preferably (optionally) arranged here between the outer first radar modules 12 (or in a region that lies between the first radar modules 12). The second radar modules may at least partially (which is indicated in the figure for at least one row of second radar modules) lie on a line which connects the (outer) first radar modules 12. However, this need not be the case.

Specifically (which is optional), the second radar modules 13 are arranged in two rows according to FIG. 1. For example, these rows can (each) be formed by a strip (e.g., of plastic). The second radar modules 13 are here preferably located in an air intake region 14 of the motor vehicle 9.

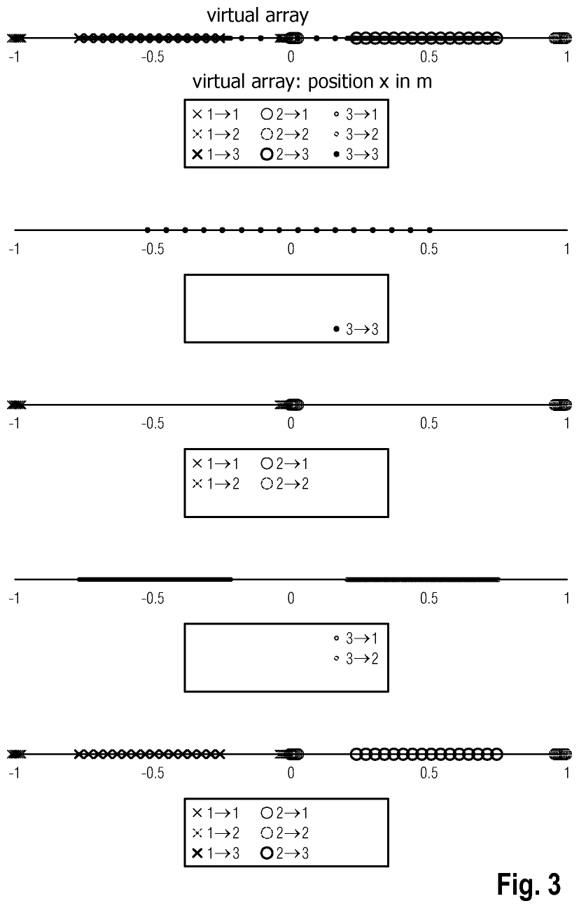

FIG. 2 shows in schematic view two first (or large) radar modules 12a, 12b (radar 1 and radar 2) (each) designed as an azimuth array, which are arranged or formed mirror symmetric to each other.

The first radar modules (also referred to as: radar 1, and radar 2) can optionally each have a transmitting antenna Tx1 or Tx2 and 16 receiving antennas Rx1 or Rx2, which have a distance of, for example, 0.58λ from one another (in the first representation as a whole, in the subsequent representations in sections). In addition, for example, 16 second (small) radar modules (TRX elements) can have distance of, for example, 15*0.58λ centrally (between radar 1 and radar 2). Each of the (here exemplarily 16) second radar modules can have (exactly) one transmitting antenna and (exactly) one receiving antenna, which are designated as Tx3 and Rx3, respectively. The second radar modules altogether can also be referred to as a radar module group or “radar 3” for short. With such an arrangement virtual arrays with partially overlapping (virtual) elements result.

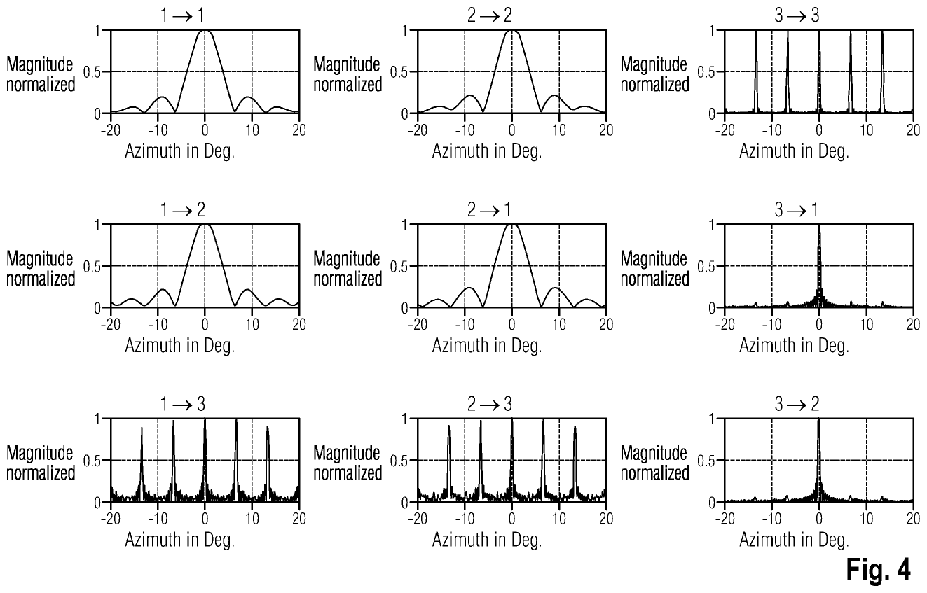

A virtual (total) array is shown in FIG. 3 (top: complete; in the further drawings: partial). Furthermore, in FIG. 3 it is shown which positions are (virtually) set, whereby “1->1”, for example, is intended to mean that this is an operation that concerns radar module 1 alone (it is therefore a matter of the signal transmitted by radar module 1 and received accordingly). Here. the “1” stands, therefore, for “radar module 1” or one of the (two) first radar modules. Correspondingly, the “2” stands for the radar module 2 (radar 2), so that, for example, 1->2 means that it is a question here of the signal transmitted by radar 1 and received by radar 2. The digit “3” again describes the group of second radar modules (TRX elements), for example according to FIG. 2.

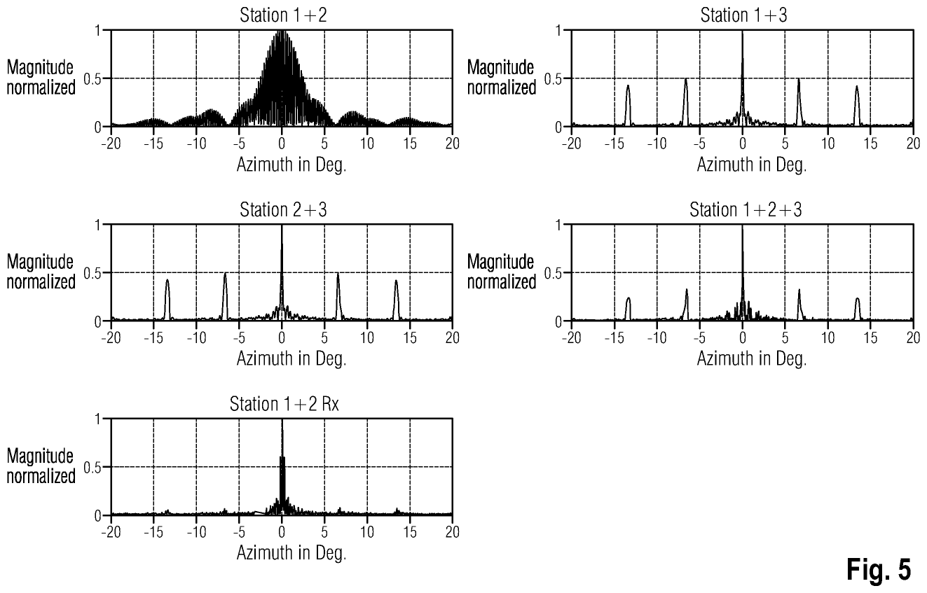

The signals resulting (simulated here) in the corresponding radar modules or the group of second radar modules are shown in FIG. 4. As can be seen, for example, one of the first radar modules (e.g., radar 1) has a comparatively low resolution or a comparatively wide main lobe according to the diagram in the top left of FIG. 4. The diagram at the top right in FIG. 4 again shows comparatively pronounced side lobes. This diagram describes the situation as it exists for the group of second radar modules (TRX elements).

The diagrams in the middle and bottom right in turn show the result of the arrangement according to the disclosure, in which both the group of second radar modules as well as a respective first radar module (as the respective receiving module) contribute accordingly.

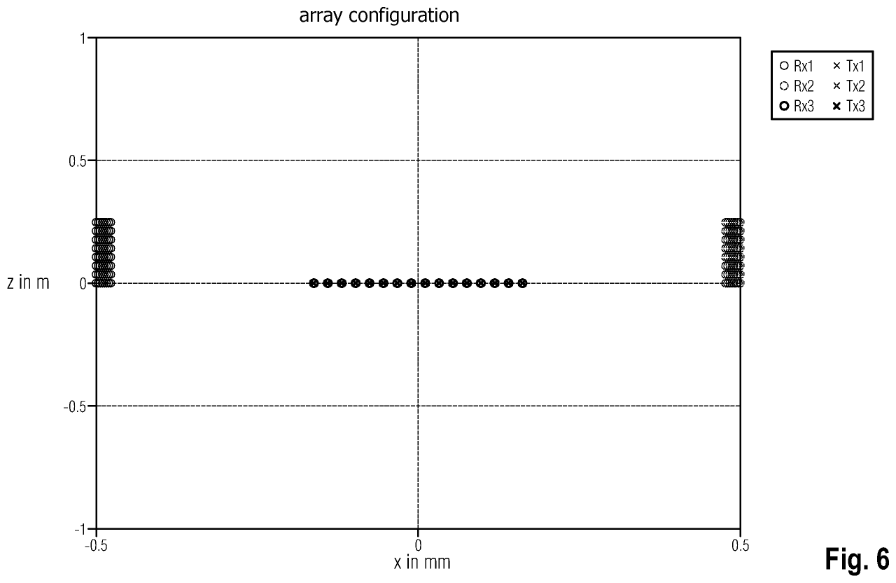

In FIG. 5 it is shown how the individual radar modules can interact with each other or which (possibly combined) signals can result. In FIG. 5, top left, the (combined) signal is shown as it results when both radar 1 as well as radar 2 transmit and receive (respectively). This is designated as “Station 1+2”. Correspondingly, “Station 1+3” in FIG. 5, top right, means that here radar 1 as well as the radar module group “3” transmit and receive (respectively). In the case 1→1 the imaging can be based on an antenna array of radar 1; in the case 2→2 on the antenna array of radar 2. In the case 1+2 all antennas of radar 1 and 2 contribute to the imaging. This results in an overall array that has comparatively many antennas on the right and left sides; in the middle, however, there is a comparatively large “gap” so that the array is comparatively “sparse” (sparsely occupied). The diagrams in FIG. 5 (at the top left of this example) can then be generated, for example, by an angle estimation algorithm (e.g., Delay and Sum Beamformer).

Accordingly, “Station 2+3” in FIG. 5, centre left, means that radar 2 and the radar module group “3” transmit and receive (respectively). In FIG. 5, centre right, “Station 1+2+3” means that the radar modules 1 and 2 as well as radar module group 3 both transmit as well as receive (wherein the combined receiving signal is shown).

In FIG. 5, bottom left again a case is shown (marked with “1+2 RX”) in which radar 1 and 2 as well as the radar module group (radar 3) are transmitting, but only radar modules 1 and 2 are receiving.

Basically, it can be seen in FIG. 5 that the resolution of the diagram at the top left is less good than that of the other four diagrams (or corresponding combination possibilities). The resolution is particularly high for the diagram “Station 1+2+3”, especially if one takes into account the only slightly recognisable side lobes at about 0.6 degrees in FIG. 5, bottom left (“Station 1+2 RX”).

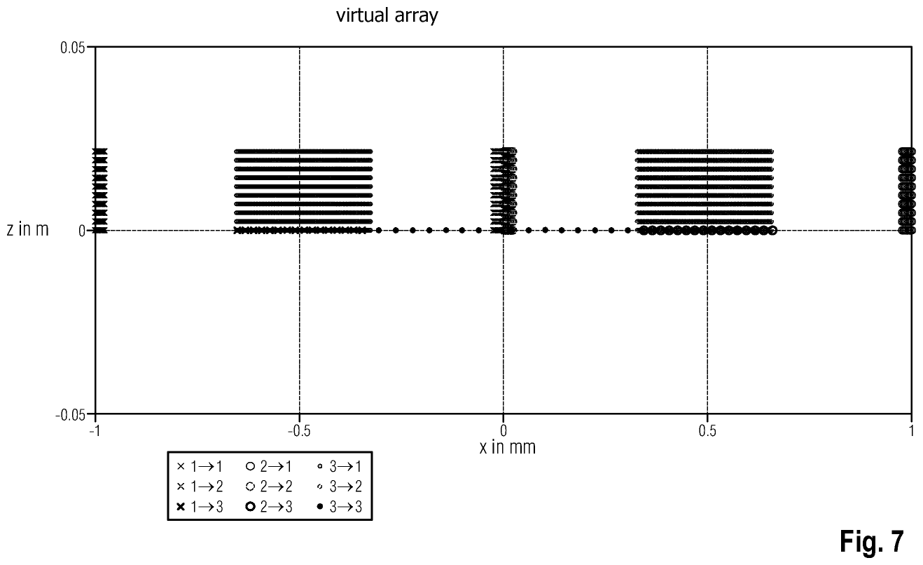

FIG. 6 shows schematically two first (large) radar modules, each designed as 2D array (for an azimuth and elevation resolution). Here, too, the first radar modules correspond to each other or are mirrored against each other. In this example, the first radar modules may generally comprise a plurality of RX elements (arranged in both azimuth as well as elevation directions) with, for example, 0.58λ distance. Further, exemplarily 16 (one or more) TRX elements (which in total form a radar module group 3) may be formed, for example, centrally with 9*0.58λ distance (so that individual virtual elements overlap).

In FIG. 6, the receiving antennas are designated as Rx1, Tx1, Rx2, Tx2, Rx3, Tx3 (where the “1” stands for the left radar 1 in FIG. 6, the “2” for the right radar 2 in FIG. 6, and the “3” for the middle group of radar modules, also called TRX elements).

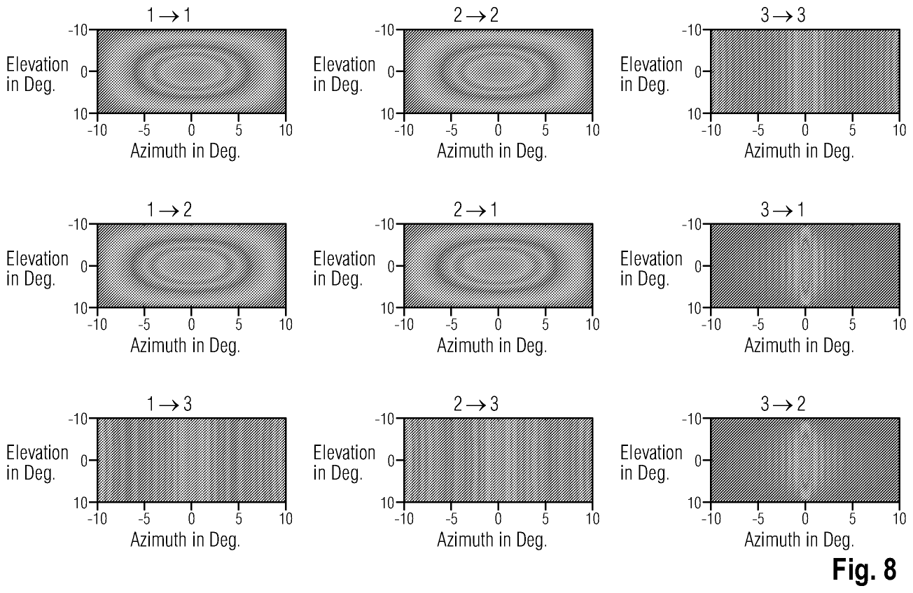

A corresponding virtual array is shown in FIG. 7.

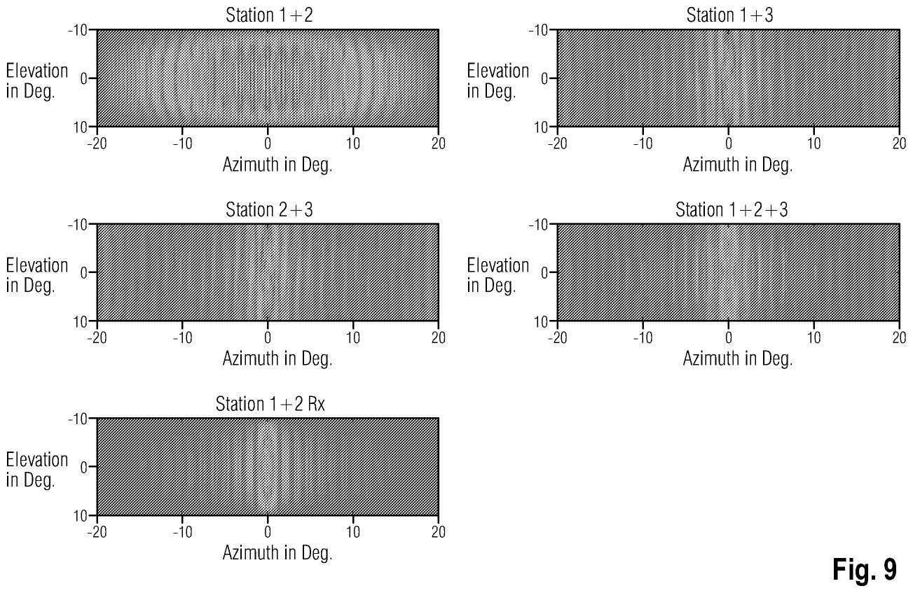

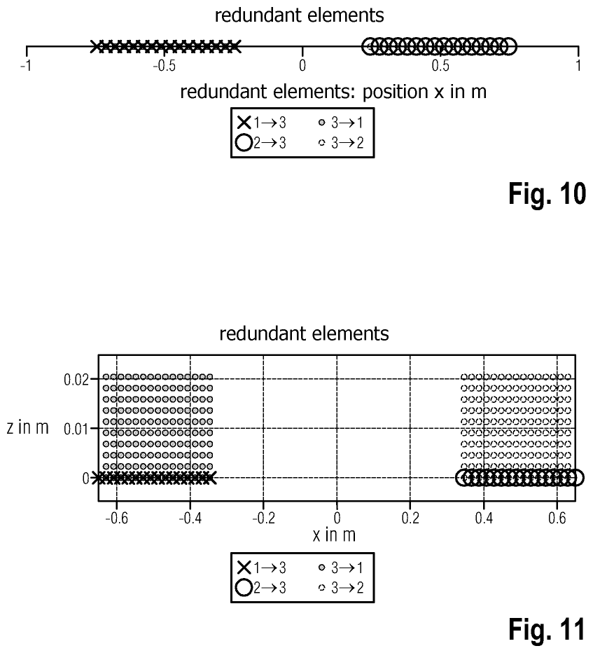

The possibility of achieving an improved resolution can be derived from FIG. 8. Various possibilities for combination are shown in FIG. 9.

As a further development of FIGS. 6 and 7, also additional TRX elements can be arranged at different heights, e.g., on an A-pillar.

A grid of possibly redundant elements in the first radar modules (left and right in FIG. 7) is advantageous, cf. FIG. 8, top right as well as centre right.

The resolution can be about 0.8 degrees in the azimuth direction and 12 degrees in the elevation direction (see FIG. 8, top right and centre right).

An assignment of transmitting or receiving antennas is possibly exchangeable (whereby a comparatively high number of receiving antennas or receiving channels is considered advantageous).

Deviating from FIG. 8, one of the two radar modules 1, 2 can also be dispensed with.

In general, redundant elements can be realised in both dimensions (azimuth or elevation).

Advantages that can be achieved with embodiments lie, for example, in the fact that the respective radar system can be expanded in a modular manner (for example in the form of, in particular thin, strips). If necessary, a comparatively large radar module can be dispensed with in the centre or in the region of an air intake, which enables an unhindered flow-in of air.

Possibly overlapping elements in the respective virtual arrays can be used for the correction of an installation position.

Various combinations of different radar types are possible.

Multiplexing is comparatively easy to perform using a comparatively small frequency and/or time offset.

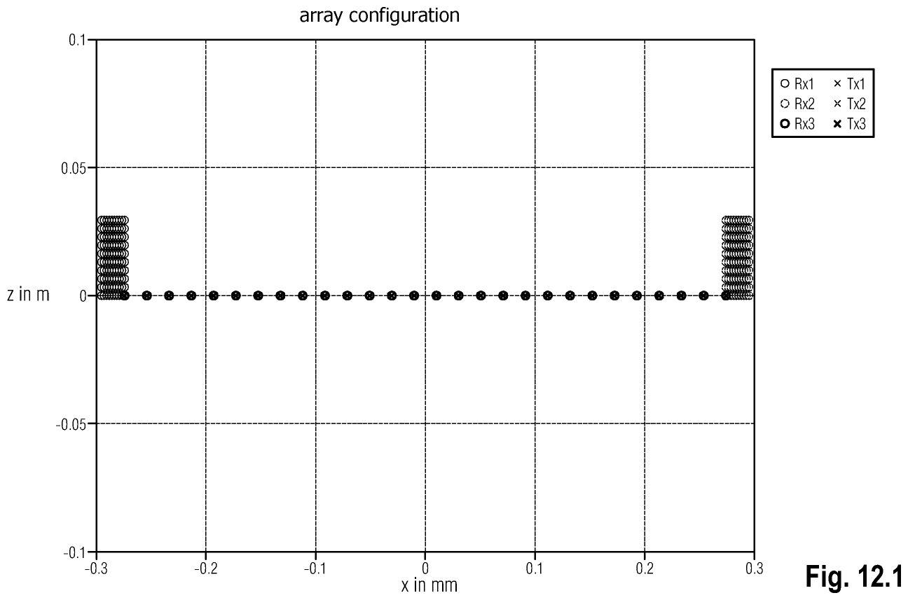

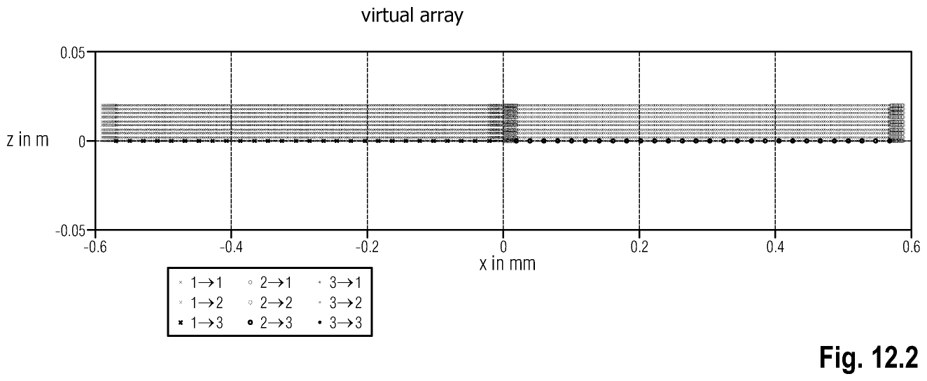

With the help of FIGS. 10 and 11, further configuration possibilities or properties of embodiments of the disclosure are described.

According to the embodiment, one possible configuration aims at the goal that at least one comparatively large virtual ULA (uniform linear array) or URA (uniform rectangular array) is created and preferably comparatively few elements (radar modules) have to be installed in a central region of the vehicle. Sparse (sparsely occupied) arrays in combination with a suitable reconstruction method would also be conceivable. An “L-arrangement” can, if necessary, be structured into a “|” outside and “_” inside (and further preferably have at least one common element), whereby, if necessary, a comparatively large (or first) radar module, in particular in the form of a URA, can be arranged in the middle.

A phase correction can be performed possibly with the common element(s). Redundant elements in the respective virtual array can enable an additional correction of a fluctuation or change of the installation position of middle radar modules (elements) (whereby a phase correction is preferably also enabled by this, whereby an installation can be carried out without a TRX element if necessary, whereby a correction can additionally be carried out in the near field).

The second radar modules are preferably arranged on a strip (for example with a common bus for a tract, trigger and ADC data). Larger amounts of data then accumulate in particular at the first radar modules, whereby a processing can take place there or in a further evaluation unit (if necessary centrally).

FIG. 10 shows redundant elements (in a respective azimuth array).

Additional elements can be provided by a common channel (under phase correction) and overlapping sub-arrays (under correction of the installation position) (alternatively also without a common element).

FIG. 11 shows elements (both in azimuth direction as well as in elevation direction). Grids of redundant (virtual) elements can be created that can be used for correction in both dimensions (as well as, for example, the cruise phase).

For example, under a number plate in an example, approximately 60 mm to 110 mm can be used for the installation of radar modules. For example, a first radar module may be installed under the number plate. However, it is preferable if two first radar modules (left and right outside) are installed. In further embodiments, corresponding first radar modules can be used both under the number plate as well as on the outer left and right.

Furthermore, for example, three strips in the region of an air intake (at the front of the vehicle) can be utilised to arrange second radar modules.

In total, for example, a first radar module can be arranged in the middle or (if necessary, additionally) two first radar modules on the left and right outside (with either a single or double resolution in azimuth).

Furthermore, a strip with second radar modules or two or more strips with second radar modules can be arranged one above the other (with either a single or double resolution in elevation).

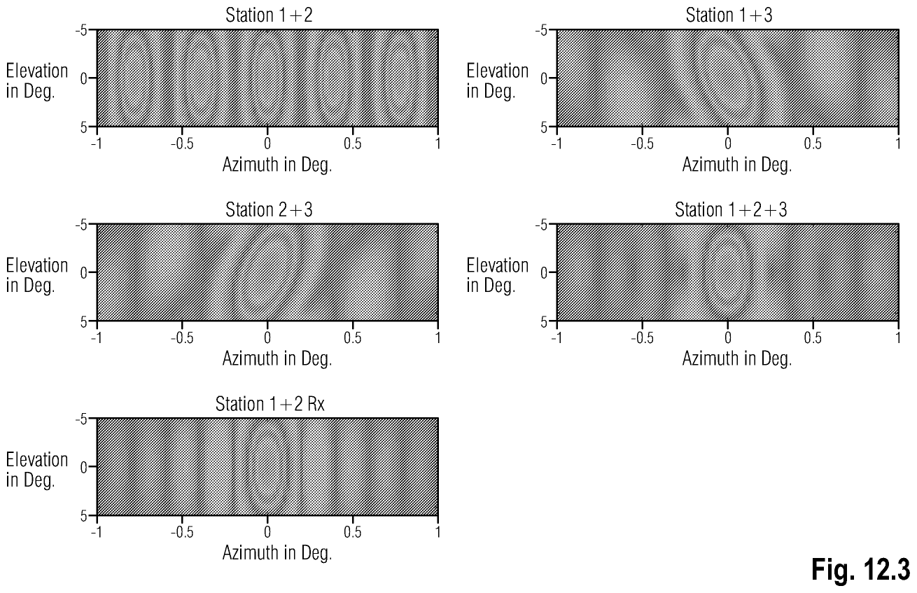

FIG. 12 shows a simulation. In the elevation direction, only a 20 mm aperture is simulated (due to a memory limitation of the simulation software). Therefore, the corresponding value would have to be multiplied by 5.5 or 11, for one or two strips respectively; the achieved resolution would therefore have to be divided by these values.

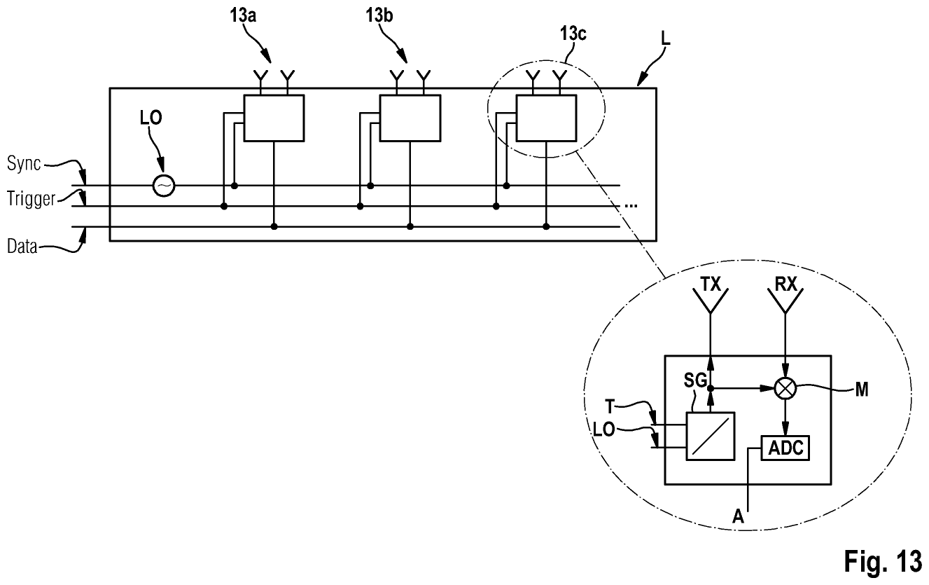

FIG. 13 schematically shows a group of second radar modules (here exemplarily or schematically three radar modules) 13a to 13c. These each have a transmitting antenna as well as a receiving antenna or a transmitting/receiving antenna. Specifically, the second radar modules 13a to 13c are arranged on a strip or rail L. The second radar module 13c is shown enlarged again (the second radar modules 13a and 13b can be analogous or identically constructed). Specifically, the (respective) second radar module 13a to 13c comprises a mixer M, an analogue-digital converter ADC as well as an output A via which data can be output. In the embodiment according to FIG. 13, a common local oscillator LO is assigned to the second radar modules 13a to 13c. Alternatively, each of the second radar modules can have its own local oscillator.

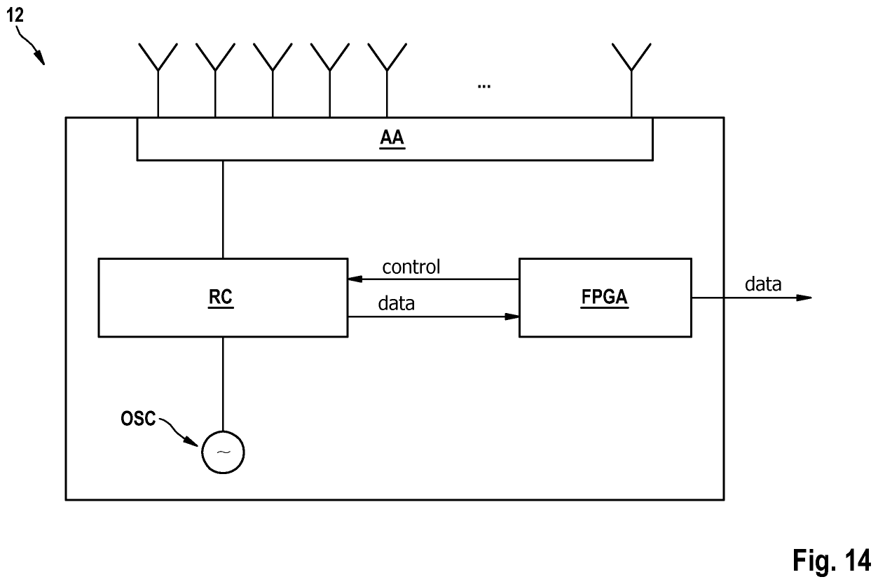

FIG. 14 schematically shows a possible design of a first radar module 12. This preferably has an antenna array AA that has, for example, a plurality of (for example 16) receiving antennas and one (possibly only one) transmitting antenna(s). Furthermore, the first radar module comprises a radar chip with signal generator RC, which in turn can be controlled by a processor or FPGA. Data can be transmitted from the radar chip RC to the FPGA. Furthermore, the first radar module according to FIG. 14 can output data via output A. Finally, the radar module according to FIG. 14 has an oscillator OSC.

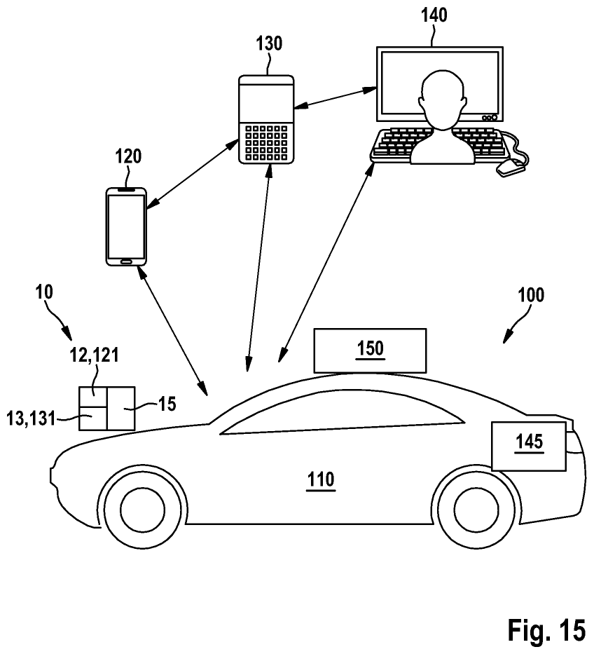

FIG. 15 shows a system 100 comprising an autonomous vehicle 110 and a radar measurement system (radar system) 10 according to embodiments. The radar measurement system 10 comprises at least one first radar module 12 with at least one first radar antenna 121 (to transmit and/or receive corresponding radar signals), and at least one second radar module 13 with at least one second radar antenna 131 (to transmit and/or receive corresponding radar signals), as well as an evaluation unit 15.

The system 100 may comprise a passenger input device and/or output device 120 (passenger interface), a vehicle coordinator 130 and/or an external input and/or output device 140 (remote expert interface; for example for a control centre). In embodiments, the external input and/or output device 140 may allow an external (to the vehicle) person and/or device to make and/or modify settings on or in the autonomous vehicle 110. This external person/device may be different from the vehicle coordinator 130. The vehicle coordinator 130 may be a server.

The system 100 enables the autonomous vehicle 110 to have a driving behaviour dependent on parameters that to modify and/or set by a vehicle passenger (for example, by means of the passenger input device and/or output device 120) and/or other persons and/or devices involved (for example, via the vehicle coordinator 130 and/or the external input and/or output device 140). The driving behaviour of an autonomous vehicle may be predetermined or modified by (explicit) input or feedback (for example, by a passenger that specifies a maximum speed or a relative comfort level), by implicit input or feedback (for example, a pulse of a passenger), and/or by other suitable data and/or communication means for a driving behaviour or preferences.

The autonomous vehicle 110 is preferably a fully autonomous motor vehicle (e.g., car and/or truck), but may alternatively or additionally be a semi-autonomous or (other) fully autonomous vehicle, for example a watercraft (boat and/or ship), a (particularly unmanned) aircraft (plane and/or helicopter), a driverless motor vehicle (e.g., car and/or truck) et cetera. Additionally or alternatively, the autonomous vehicle may be configured in such a way that it switches between a semi-automatic state and a fully-automatic state, wherein the autonomous vehicle may have characteristics that may be associated with both a semi-automatic vehicle as well as a fully-automatic vehicle (depending on the state of the vehicle).

The autonomous vehicle 110 preferably comprises an on-board computer 145.

The evaluation unit 15 may be at least partially arranged in and/or on the vehicle 110, in particular (at least partially) integrated in the on-board computer 145, and/or (at least partially) integrated in a calculation unit in addition to the on-board computer 145. Alternatively or additionally, the evaluation unit 15 may be (at least partially) integrated in the first and/or second radar module 12, 13. If the evaluation unit 15 is (at least partially) provided in addition to the on-board computer 145, the evaluation unit 15 may be in communication with the on-board computer 145 so that data can be transmitted from the evaluation unit 15 to the on-board computer 145 and/or vice versa.

Additionally or alternatively, the evaluation unit 15 may be (at least partially) integrated with the passenger input device and/or output device 120, the vehicle coordinator 130, and/or the external input and/or output device 140. In particular, in such a case, the radar measurement system may have a passenger input device and/or output device 120, a vehicle coordinator 130, and/or an external input and/or output device 140.

In addition to the radar modules 12, 13, the autonomous vehicle 110 may comprise at least one other sensor device 150, (for example, at least one computer vision system, at least one LIDAR, at least one speed sensor, at least one GPS, at least one camera, etc.).

The on-board computer 145 may be configured in order to control the autonomous vehicle 110. The on-board computer 145 may further process data from the at least one sensor device 150 and/or at least one other sensor, in particular a sensor which is provided or formed by at least one radar module 12, 13, and/or data from the evaluation unit 15 to determine the status of the autonomous vehicle 110.

Based on the status of the vehicle and/or programmed instructions, the on-board computer 145 can preferably modify or control the driving behaviour of the autonomous vehicle 110. The evaluation unit 13 and/or the on-board computer 145 is (are) preferably a (general) computation unit which is adapted for an I/O communication with a vehicle control system and at least one sensor system, but may additionally or alternatively be formed by any suitable computation unit (computer). The on-board computer 145 and/or the evaluation unit 15 may be connected to the internet via wireless connection. Alternatively or additionally, the on-board computer 145 and/or the evaluation unit 15 may be connected to any number of wireless or wired communication systems.

For example, any number of electrical circuits, in particular as part of the evaluation unit 15 and/or the on-board computer 145, the passenger input device and/or output device 120, the vehicle coordinator 130 and/or the external input and/or output device 140 may be implemented on a circuit board of a corresponding electronic device. The circuit board may be a general circuit board (“circuit board”) that may have various components of an (internal) electronic system, an electronic device and connections for other (peripheral) devices. Specifically, the circuit board may have electrical connections through which other components of the system may communicate electrically (electronically). Any suitable processors (for example, digital signal processors, microprocessors, supporting chipsets, computer-readable (non-volatile) memory elements, etc.) may be coupled to the circuit board (depending on corresponding processing requirements, computer designs, etc.). Other components, such as an external memory, additional sensors, controllers for audio-video playback, and peripheral devices may be connected to the circuit board, such as plug-in cards, via cables, or integrated into the circuit board itself.

In various embodiments, functionalities which are described herein may be implemented in emulsified form (as software or firmware), with one or more configurable (for example, programmable) elements which are arranged in a structure that enables that function. The software or firmware that provides the emulation may be provided on a (non-volatile) computer-readable storage medium comprising instructions that allow one or more processors to perform the corresponding function (the corresponding process).

The above description of the embodiments shown does not purport to be exhaustive or restrictive as to the exact embodiments as described. While specific implementations of and examples of various embodiments or concepts have been described herein for illustrative purposes, deviating (equivalent) modifications are possible as will be apparent to those skilled in the art. These modifications may be made taking into account the detailed description above or the figures.

Various embodiments may comprise any suitable combination of the embodiments described above, including alternative embodiments of embodiments that are described above in conjunctive form (e.g., the corresponding “and” may be an “and/or”).

In addition, some embodiments may comprise one or more objects (e.g., in particular, non-volatile computer-readable media) with instructions stored thereon that, when executed, result in an action (a method) according to any of the embodiments described above. In addition, some embodiments may comprise devices or systems having any suitable means for performing the various operations of the embodiments described above.

In certain contexts, the embodiments discussed herein may be applicable to automotive systems, in particular autonomous vehicles (preferably autonomous automobiles), (safety-critical) industrial applications and/or industrial process controls.

Furthermore, parts of the described radar system or the described radar measurement system (or in general: wave-based measurement system) may comprise electronic circuits to perform the functions as well as methods described herein. In some cases, one or more parts of the respective system may be provided by a processor which is specifically configured for performing the functions as well as method steps described herein. For example, the processor may include one or more application-specific components, or it may include programmable logic gates which are configured in such a way that they execute the functions described herein.

The disclosed subject matter may have application in airspace surveillance and/or and/or near field imaging (for example, indoor monitoring, vital sign detection) and/or in a railway radar and/or in a truck (it should be noted, though, that a truck front is particularly well suited in the context of the present disclosure) and/or integrated into an A, B or C pillar.

A reduced number of physical channels or antennas can be achieved (a hardware effort becomes a software effort). A comparatively simple integration of an equally large (virtual) array can be made possible (example: integration of an automotive radar into the radiator). The array does not have to be made planar. A self-calibration through redundancy is possible. The strips explained above can be pre-calibrated (ex works). A flexible design according to the modular principle is possible (example: basic package: 2 radars on the sides of a car; premium package: strips in the middle for additional resolution+functionality). Comparatively good resolutions can be achieved in a vehicle, e.g., passenger car. An array size achievable with the present disclosure is (coherently) not realisable in any other way (one can, for example, use the maximum aperture area offered by the car).

It should be noted at this point that all of the parts or functions described above individually and in any combination, in particular the details shown in the figures, are claimed to be essential to the disclosure. Modifications thereof are apparent to the person skilled in the art.

Furthermore, it is pointed out that a scope of protection as broad as possible is sought. In this respect, the disclosure contained in the claims can also be made more precise by features which are described with further features (even without these further features being necessarily included). It is explicitly pointed out that round brackets and the term “in particular” in the respective context are intended to emphasise the optionality of features (which is not intended to mean, conversely, that without such identification a feature is to be regarded as mandatory in the corresponding context).

1. A radar system for detecting surroundings of an object, the system comprising:
at least one first radar module comprising at least one antenna and at least one second radar module, the at least one second radar module non-coherent with the at least one first radar module, the at least one second radar module comprising at least one antenna,
wherein the at least one first radar module and the at least one second radar module are arranged in a distributed manner, and
wherein at least one first radar module is configured differently from at least one second radar module, being at least one of larger than the at least one second radar module or having more transmitting antennas that the at least one second radar module.

2. The radar system according to claim 1, comprising at least one evaluation unit preferably configured to process transmitting and receiving signals from the at least one first radar module and the at least one second radar module such that the at least one first radar module is virtually located to a position of the at least one second radar module.

3. The radar system according to claim 1, wherein the at least one second radar module, by contrast with the at least one first radar module, comprises only one transmitting antenna or only one receiving antenna.

4. The radar system according to claim 1, wherein at least one evaluation device is configured to process transmitting and receiving signals of the at least one first radar modules and the at least one second radar module to provide modified measurement signals that are coherent with each other.

5. The radar system according to claim 1, wherein at least two radar modules are interconnected via a communication channel.

6. The radar system according to claim 1, wherein the at least one second radar module is arranged in a region of an air intake of a vehicle or below a number plate mounting region of vehicle.

7. The radar system according to claim 1, wherein the at least one first radar module comprises at least one transmitting antenna and at least two receiving antennas.

8. The radar system according to claim 1, wherein at the at least one first radar module or the at least one second radar module is located in a center of an object,
wherein the at least one second radar module is arranged between at least two respective first radar modules, and
wherein the at least one second radar module has a smaller distance from each of the at least two respective first radar modules than a distance of the at least two respective first radar modules from each other.

9. The radar system according to claim 1, comprising at most four first radar modules.

10. A method, comprising:
generating a first signal in a first radar module;
transmitting the first signal via a path,
generating a further first signal a second radar module,
transmitting the further first signal via the path,
in a first evaluation device in the first radar module, forming a first comparison signal from the first signal of the first radar module and from a received further first signal from the second radar module, and
in a second evaluation device in the second radar module, forming a further comparison signal from the further first signal of the second radar module and from a received first signal from the first radar module,
wherein the further comparison signal is transmitted from the second radar module to the first radar module,
wherein the first radar module and the second radar module are arranged in a distributed manner, and
wherein the first radar module is configured differently from the second radar module, being at least one of larger than the second radar module or having more transmitting antennas that the second radar module.

11. The method of claim 10, comprising forming a comparison signal from the first comparison signal and the further comparison signal.

12. The method of claim 11, comprising:
compensating for deviations of the first comparison signal and further comparison signals which are caused by systematic deviations in the first radar modules and the second radar module, and
using at least one complex value from the first comparison signal or from a signal which was derived from the first comparison signal, to adapt at least one complex value of the further comparison signal or a value of a signal which was derived from the further comparison signal to form an adapted signal,
wherein the forming the adapted signal is by a mathematical operation comprising a vectorial sum or a vectorial difference of complex values or a sum or a difference of phases of the complex values.

13. The method of claim 12, wherein the comparison signal corresponds to a comparison signal generated with a coherent radar system.

14. The method of claim 10, comprising enabling coherent processing, via a phase correction, on a basis of overlapping elements of at least two virtual radar arrays.

15. The method of claim 10, wherein at least two virtual radar arrays are formed, wherein each virtual radar array comprises at least one element that overlaps with at least one element of another virtual radar array.

16. The method of claim 10, comprising performing an online calibration.

17. The method of claim 10, comprising performing an SAR technique or corresponding imaging method.

18. The system of claim 1, wherein the at least one first radar module and the at least one second radar module are configured as respective FMCW radar modules or as respective OFDM radar modules.

19. The system of claim 1, further comprising the object, the object comprising a vehicle.

20. The method of claim 15, wherein each virtual radar array comprises at least one outer element that overlaps with at least one outer element of another virtual radar array.
